(19) United States
(12) Patent Application Publication
(10) Pub. No.: US 2009/0194525 A1
(43) Pub. Date: Aug. 6, 2009

(54) HEATING ELEMENT USING CARBON NANO TUBE

(75) Inventors: Taek soo Lee, Gyeonggi-do (KR); Chang woo Seo, Dae-jeon (KR); Seung Kyung Kang, Gyeonggi-do (KR)

Correspondence Address: RODMAN RODMAN, 10 STEWART PLACE, SUITE 2CE, WHITE PLAINS, NY, 10603, US

(73) Assignee: EXAENC CORP., Seoul (KR)

(21) Appl. No.: 12/162,657

(22) PCT Filed: Feb. 2, 2007
(86) PCT No.: PCT/KR2007/000572

§ 371 Date: Jul. 30, 2008

(30) Foreign Application Priority Data
Feb. 3, 2006 (KR) 10-2006-0010882

(51) Int. Cl. H05B 3/14

(52) U.S. Cl. 219/553

(57) ABSTRACT

Provided is a heating element using carbon nanotube including a heat-resistant member having a heat-resistant characteristic, a carbon nanotube coating layer formed on at least one surface of the heat-resistant member, and a pair of electrodes electrically connected to the carbon nanotube coating layer and inducing heating of the carbon nanotube coating layer when connected to power. The manufactured in a simple process of coating a heat-resistant member with carbon nanotube, relatively reduce the overall manufacturing time, easily change the shape and specifications, and have a heating efficiency higher than that of a heating element having a different shape and material.

### TECHNICAL FIELD

The present invention relates to a heating element using carbon nanotube, and more particularly, to a heating element using carbon nanotube which can be manufactured in a simple process of coating a heat-resistant member with carbon nanotube and have a heating efficiency higher than that of a heating element having a different shape and material.

### BACKGROUND ART

In general, a heating element is a material that converts electric energy to heat energy and transfers energy by radiating the heat to the outside. The heating element is widely used for various home appliances or throughout general industrial fields.

The heating element can be classified into metal heating elements, nonmetal heating elements, and other heating elements according to the materials thereof. The metal heating element which forms a main stream of the initial heating elements includes Fe—Cr—Al based materials, Ni—Cr based materials, and high melting point metals (platinum, Mo, W, and Ta). The metal heating element is formed by processing the surface of a metal pipe filled with an inorganic insulation material such as MgO, using a far infrared radiation material. The nonmetal heating element includes silicon carbide, molybdenum silicide, lanthanum chromite, carbon, and zirconia. The other heating element includes a ceramic material, barium carbonate, and a thick film resistor.

The heating element can be classified into a linear heating element that is usually referred to as a heating line and a surface-shaped heating element according to the outer shape thereof. A typical example of the linear heating element is a filament and a nichrome wire. The surface-shaped heating element collectively refers to all heating elements that generate heat from the overall surface of the heating element by installing a metal electrode at the opposite ends of a thin surface conductive heating element and insulation-processed using an insulation member. For example, there are surface-shaped heating elements using a metal thin film, a heating pigment (carbon black), and carbon fiber.

Recently, due to the newly issued energy saving and environmental problems, a lot of studies have been made about the manufacture and applicable fields of the heating element in many countries.

A nichrome wire made of an alloy of nickel and chrome is usually used for a heating resistant portion of a conventional heating element. In the nichrome wire heating element, electricity flow through a single wire so that, when any portion of the wire is cut, the flow of the electricity is discontinued. Also, as the time passes, the nichrome wire gradually becomes thinner due to the oxidation reaction so that the control of temperature is difficult and the life span thereof is shortened.

As one of other heating elements, the ceramic heating element is formed by making a green sheet in a soft status using ceramic slurry, cutting the green sheet in an appropriate size, printing resistance on the surface of the green sheet using metal paste, depositing the green sheet with the printed resistance and the green sheet without the printed resistance and heating and pressing the deposited green sheets, and curing the green sheet at temperatures of 1400° C.-1700° C.

However, in the conventional heating element using the ceramic slurry, since a separate dedicated equipment is needed to press the green sheet, a considerable equipment investment cost is needed. The curing temperature needs to be increased high and simultaneously more than 24 hours are needed for manufacturing so that the overall manufacturing process prolongs.

Also, in the curing process, since the volume is contracted by about 15%, an accurate specifications control is difficult. Further, in the curing process, since a large amount of a crystallizer included in the green sheet remains as residual carbon due to incomplete combustion, the electricity-resistant and voltage-resistant characteristics are critically damaged.

In the conventional heating elements, the overall manufacturing time is excessively consumed, the manufacturing process is complicated, the change of the shape and specifications is not easy, and the investment cost is high so that the productivity and quality of the heating elements are deteriorated.

### DISCLOSURE OF INVENTION

### Technical Problem

To solve the above and/or other problems, the present invention provides a heating element using carbon nanotube which can be manufactured in a simple process of coating a heat-resistant member with carbon nanotube, relatively reduce the overall manufacturing time, easily change the shape and specifications, and have a heating efficiency higher than that of a heating element having a different shape and material.

Also, the present invention provides a heating element using carbon nanotube which can almost prevent the occurrence of a phenomenon that a binder is thermally dissolved when high temperature heating is embodied, so as to be used almost semi-permanently when the high temperature heating is embodied.

### Technical Solution

According to an aspect of the present invention, a heating element using carbon nanotube comprises a heat-resistant member having a heat-resistant characteristic, a carbon nanotube coating layer formed on at least one surface of the heat-resistant member, and a pair of electrodes electrically connected to the carbon nanotube coating layer and inducing heating of the carbon nanotube coating layer when connected to power.

The carbon nanotube coating layer is formed by injecting carbon nanotube dispersive liquid onto a surface of the heat-resistant member.

The heating element further comprises an insulation coating layer formed on an upper surface of the carbon nanotube coating layer and electrically insulating the carbon nanotube coating layer.

The insulation coating layer is a ceramic adhesive.

The heating element further comprises a copper lead wire electrically connected to each of the electrodes, wherein the copper lead wire is arranged between the carbon nanotube coating layer and the insulation coating layer.

The heat-resistant member is any one selected from a group consisting of aluminum oxide and zirconium.

The heat-resistant member is any one selected from a group consisting of polyethylene terephthalate (PET), polyethylene nitrate (PEN), and amide film.

### ADVANTAGEOUS EFFECTS

As described above, according to the present invention, the can be manufactured in a simple process of coating a heat-resistant member with carbon nanotube, relatively reduce the overall manufacturing time, easily change the shape and specifications, and have a heating efficiency higher than that of a heating element having a different shape and material. Thus, the heat element having a high quality at a low investment cost is provided so that the productivity and quality can be improved.

Also, since carbon nanotube in a water-dispersive state is used instead of an organic binder in coating the carbon nanotube with a heat-resistant element,

### BRIEF DESCRIPTION OF THE DRAWINGS

FIG. 1 is a perspective view of a heating element using carbon nanotube according to an embodiment of the present invention;

FIG. 2 is an exploded perspective view of the heating element of FIG. 1; and

FIG. 3 is a flow chart for explaining the manufacturing process of the heating element of FIG. 1.

### BEST MODE FOR CARRYING OUT THE INVENTION

The attached drawings for illustrating preferred embodiments of the present invention are referred to in order to gain a sufficient understanding of the present invention, the merits thereof, and the objectives accomplished by the implementation of the present invention. Hereinafter, the present invention will be described in detail by explaining preferred embodiments of the invention with reference to the attached drawings. Like reference numerals in the drawings denote like elements.

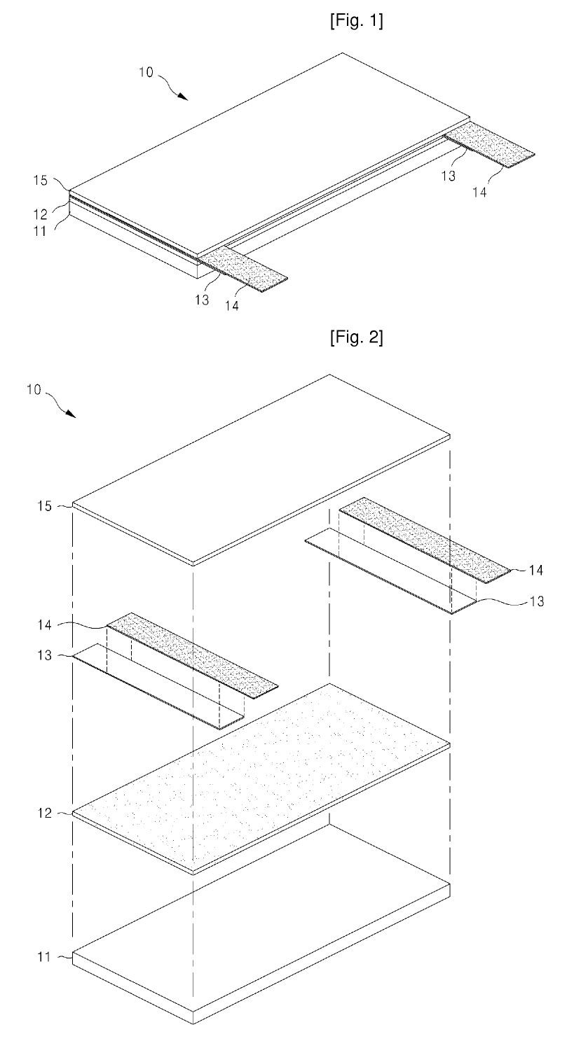

FIG. 1 is a perspective view of a heating element using carbon nanotube according to an embodiment of the present invention. FIG. 2 is an exploded perspective view of the heating element of FIG. 1. Referring to FIGS. 1 and 2, a heating element 10 using carbon nanotube according to an embodiment of the present invention includes a heat-resistant member 11, carbon nanotube coating layer 12, an electrode 13, a copper lead wire 14, and an insulation coating layer 15.

The heat-resistant member 11 forms an outer frame of the heating element 10. The thickness and shape of the heating element 10 are adjustable according to the purpose and position of the heating element 10. In general, since the thicknesses of the carbon nanotube coating layer 12, the electrode 13, the copper lead wire 14, and the insulation coating layer 15 are smaller than that of the heat-resistant member 11, most of the thickness of the heating element 10 is taken by the heat-resistant member 11.

In the present embodiment, the heat-resistant member 11 has a rectangular flat panel having a predetermined thickness. However, since carbon nanotube spray liquid that becomes a heat resistive material is coated on the heat-resistant member 11 in a spray type, the heat-resistant member 11 can be modified into various shapes including a curved surface, as necessary.

As the heat-resistant member 11, aluminum oxide or zirconium that is a sort of ceramic is mainly used for the heating element 10 which embodies high temperature heating at about 100° C.-400° C. For the heating element 10 embodying low temperature heating at about 40° C.-100° C., any one selected from a group consisting of polyethylene terephthalate (PET), polyethylene nitrate (PEN), and amide film is used. The surface of the heat-resistant member 11 preferably have lots of fine pores so that carbon nanotube particles in a nano size can be easily seated thereon.

The carbon nanotube coating layer 12 is formed on a surface of the heat-resistant member 11. That is, the carbon nanotube coating layer 12 is coated on the surface of the heat-resistant member 11 by spraying carbon nanotube dispersed liquid onto the surface. Since the organic binder does not need to be used, the phenomenon that the organic binder is thermally dissolved does not occur when high temperature heating is embodied. Even when the high temperature heating is embodied, the carbon nanotube can be used semi-permanently. In other words, when the carbon nanotube coating layer 12 includes the organic binder, heating is limited not to exceed the heat-resistant temperature of the organic binder. Since the organic binder is not used in the present invention, the heating characteristic can be embodied within the heat-resistant temperature of the heat-resistant member 11.

The coating mass per unit area of the carbon nanotube coating layer 12 is 4 g-10 g/m², in particularly, 4 g-7 g/m² in the present embodiment.

For reference, the carbon nanotube is an anisotropic material having a diameter of several through several hundreds micrometers (mm) and a length of several through several hundreds micrometers (mm). In the carbon nanotube, a carbon atom is combined to three other carbon atoms so that form a hexagonal honeycomb. The nanotube structure can be made by drawing a honeycomb on a plane paper and roll the paper. That is, a nanotube has a shape of an empty tube or cylinder. The reason for naming this structure a nanotube is that the diameter of the tube is normally as small as 1 nano meter ( 1/1,000,000,000 meter). The carbon nanotube becomes an electrical conductive body (armchair) such as metal or a semiconductor (zigzag structure) according to the angle at which the paper where the honeycomb is drawn is rolled.

The carbon nanotube has a superior mechanical characteristic, a superior electrical selection characteristic, a superior field emission characteristic, and a high efficient hydrogen storing medium characteristic and is highlighted as a dream new material.

The carbon nanotube is manufactured by a high synthesis technology. A synthesis method includes an electric discharge method, a pyrolysis method, a laser deposition method, a plasma chemical vapor deposition method, a heat chemical vapor deposition method, and an electrolysis method. The carbon nanotube can be used as an electron emitter, a vacuum fluorescent display (VFD), a white light source, a field emission display (FED), a lithium ion secondary electrode, a hydrogen storage fuel battery, a nano wire, a nano capsule, nano tweezers, an AFM/STM tip, a single electron device, a gas sensor, fine parts for medical engineering, and a high performance multifunctional body.

The electrode 13 is electrically connected in a pair to the carbon nanotube coating layer 12. That is, as shown in FIGS. 1 and 2, a pair of the electrodes 13 are electrically connected to the carbon nanotube coating layer 12 with a predetermined gap between the electrodes 13.

The electrode 13 can be manufactured of silver (Ag) and has a shape like a rectangular panel as shown in the drawing. However, the shape of the electrode 13 can be appropriately modified as necessary. As power is applied to the carbon nanotube coating layer 12 through the electrode 13, the carbon nanotube coating layer 12 dissipates heat.

The copper lead wire 14 is provided in a pair like the electrode 13 to contact the upper portion of each electrode 13. The copper lead wire 14 works as a connection port to connect the electrode 13 and the power.

The copper lead wire 14 is manufactured to have substantially the same area as the electrode 13 and provided to contact the upper portion of the electrode 13. The copper lead wire 14 does not exactly overlap the upper surface of the electrode 13 and is arranged to protrude to one side on the upper surface of the electrode 13. Accordingly, referring to FIG. 1, the copper lead wire 14 is exposed outside further compared to the electrode 13. However, this is a mere embodiment so that the copper lead wire 14 and the electrode 13 can be manufactured to completely overlap each other. Also, in the drawings, the copper lead wire 14 has a rectangular panel shape, the shape of the copper lead wire 14 can be diversely modified as necessary like the electrode 13.

The insulation coating layer 15 is formed on the upper surface of the carbon nanotube coating layer 12. As the insulation coating layer 15 is formed, the electrode 13 and the copper lead wire 14 are arranged between the insulation coating layer 15 and the carbon nanotube coating layer 12.

An organic or inorganic material having a heat-resistant characteristic equal to or over that of the heat-resistant member 11 is used as a material for the insulation coating layer 15. Preferably, a ceramic adhesive can be used for the insulation coating layer 15. Since the electrode 13 and the carbon nanotube coating layer are electrically insulated by the insulation coating layer 15 and the carbon nanotube coating layer 12 is prevented from contacting oxygen, oxidation is prevented.

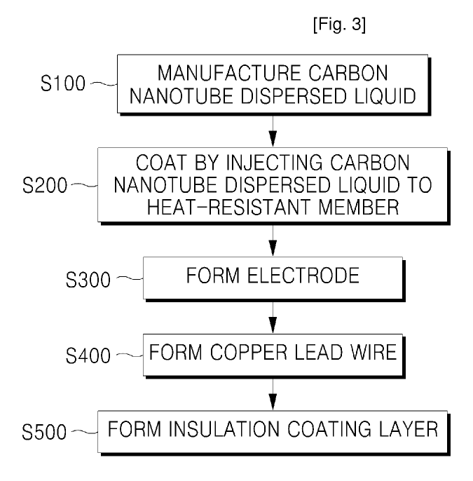

The manufacturing process of the heating element 10 using carbon nanotube configured as above is described below with reference to FIG. 3. First, a dispersion liquid in a state appropriate for being sprayed is made by mixing carbon nanotube with liquid such as water (S100). The carbon nanotube spray liquid is sprayed onto a surface of the heat-resistant member 11 in a spray injection manner to form the carbon nanotube coating layer 12 (S200).

A pair of electrodes 13 are arranged on the surface of the carbon nanotube coating layer 12 to be separated from each other (S300). A pair of copper lead wires 14 are formed on the upper surface of the electrodes 13 (S400). As described above, the copper lead wires 14 are arranged to protrude more than the electrodes 13.

The insulation coating layer 15 is formed on the carbon nanotube coating layer 12 with the electrodes 13 and the copper lead wires 14 interposed therebetween (S500). Thus, the heating element using carbon nanotube is completely manufactured.

Embodiments of measuring the heating temperature of the surface using the heating element 10 manufactured in the above-described method are shown below.

### Embodiment 1

A ceramic substrate is used as the heat-resistant member 11 and water-dispersive carbon nanotube is coated in a spray method. When the surface resistance is set to 946Ω and applied voltage is set to 132V and 220V, the heating temperatures of the surface measured in these conditions are respectively 282° C. and 409° C.

### Embodiment 2

A ceramic substrate is used as the heat-resistant member 11 and water-dispersive carbon nanotube is coated in a spray method. When the surface resistance is set to 1129Ω and applied voltage is set to 132V and 220V, the heating temperatures of the surface measured in these conditions are respectively 210° C. and 328° C.

### Embodiment 3

A ceramic substrate is used as the heat-resistant member 11 and water-dispersive carbon nanotube is coated in a spray method. When the surface resistance is set to 1274Ω and applied voltage is set to 132V and 220V, the heating temperatures of the surface measured in these conditions are respectively 192° C. and 298° C.

### Embodiment 4

A ceramic substrate is used as the heat-resistant member 11 and water-dispersive carbon nanotube is coated in a spray method. When the surface resistance is set to 1416Ω and applied voltage is set to 132V and 220V, the heating temperatures of the surface measured in these conditions are respectively 140° C. and 257° C.

TABLE 1

| | Voltage 132 V | Voltage 220 V |
|---|---|---|
| Surface Resistance 946Ω | 282° C. | 409° C. |
| Surface Resistance 1129Ω | 210° C. | 328° C. |
| Surface Resistance 1274Ω | 192° C. | 298° C. |
| Surface Resistance 1416Ω | 140° C. | 257° C. |

Table 1 tabulates the results of the embodiments 1 through 4. Referring to Table 1, it can be seen that higher temperature heating is possible as the surface resistance decreases with respect to the equally applied voltage. In particular, when the surface resistance is 946Ω and the applied voltage is 220V, it can be seen that relatively higher temperature heating of 409° C. is possible.

### Embodiment 5

A ceramic substrate is used as the heat-resistant member 11 and water-dispersive carbon nanotube is coated in a spray method. When the surface resistance is set to 1050Ω and applied voltage is set to 132V and 220V, the surface temperature and the power consumption are measured. The surface temperature and power consumption of a general PTC heater heating element (BaTiO3-based ceramic) are measured in the same method and the result of the measurement is shown in Table 2.

For reference, PTC (positive temperature resistor) refers to barium titanate based ceramic that is a semiconductor device having electric resistance that sharply increases as a temperature increases. The PTC is referred to as a static characteristic thermistor. Also, when current flows for a very short time, electric resistance increases so that current does not flow. This is a so-called switch function which is used for a television shadow mask device and a motor driving for an air conditioner. By molding the PTC in a honeycomb structure, the air passing through the PTC can be directly heated so that the PTC is used to make hair dryers or cloth driers.

TABLE 2

| | 132 V | | 220 V | |
|---|---|---|---|---|
| | Surface | Power | Surface | Power |
| | Temperature | Consumption | Temperature | Consumption |
| Carbon | 220° C. | 10 W | 340° C. | 35 W |
| Nanotube | | | | |
| Heating | | | | |
| Element | | | | |
| PTC Ceramic | 150° C. | 20 W | 243° C. | 40 W |
| Heating | | | | |
| Element | | | | |

Referring to Table 2, it can be seen that, for the identically applied voltage, the surface temperature of the carbon nanotube heating element is rather high while the carbon nanotube heating element shows a small amount of the power consumption. That is, when the carbon nanotube is used as the heating resistant portion, the carbon nanotube heating element consumes power less than the PTC ceramic heating element while the surface temperature is indicated to be higher. Thus, it can be seen that the carbon nanotube heating element exhibits a superior heating characteristic.

While this invention has been particularly shown and described with reference to preferred embodiments thereof, it will be understood by those skilled in the art that various changes in form and details may be made therein without departing from the spirit and scope of the invention as defined by the appended claims.

### INDUSTRIAL APPLICABILITY

According to the present invention, the heating element using carbon nonotube can be manufactured in a simple process of coating a heat-resistant member with carbon nanotube. The overall manufacturing time can be relatively reduced compared to the conventional technology. The shape and specifications can be easily changed. A heating efficiency is higher than that of a heating element having a different shape and material. Thus, a heating element having a high quality can be provided at a low investment cost so that productivity and quality can be improved.

Also, since carbon nanotube in a water-dispersive state not using organic binder in coating the carbon nanotube with the resistant heating element, the phenomenon that the binder is thermally dissolved hardly occurs when high temperature heating is embodied. Thus, the heating element using carbon nanotube can be used almost semi-permanently when the high temperature heating is embodied.

1. A heating element using carbon nanotube, the heating element comprising:
a heat-resistant member having a heat-resistant characteristic;
a carbon nanotube coating layer formed on at least one surface of the heat-resistant member; and
a pair of electrodes electrically connected to the carbon nanotube coating layer and inducing heating of the carbon nanotube coating layer when connected to power.

2. The heating element of claim 1, wherein the carbon nanotube coating layer is formed by injecting carbon nanotube dispersive liquid onto a surface of the heat-resistant member.

3. The heating element of claim 1, further comprising an insulation coating layer formed on an upper surface of the carbon nanotube coating layer and electrically insulating the carbon nanotube coating layer.

4. The heating element of claim 3, wherein the insulation coating layer is a ceramic adhesive.

5. The heating element of claim 3, further comprising a copper lead wire electrically connected to each of the electrodes, wherein the copper lead wire is arranged between the carbon nanotube coating layer and the insulation coating layer.

6. The heating element of claim 1, wherein the heat-resistant member is any one selected from a group consisting of aluminum oxide and zirconium.

7. The heating element of claim 1, wherein the heat-resistant member is any one selected from a group consisting of polyethylene terephthalate (PET), polyethylene nitrate (PEN), and amide film.
